(19) United States
(12) Patent Application Publication
(10) Pub. No.: US 2009/0127988 A1
(43) Pub. Date: May 21, 2009

(54) Device for a computer case cover

(76) Inventors: Sergejs Lucuks, Riga (LV); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/986,045

(22) Filed: Nov. 20, 2007

(51) Int. Cl. G06F 1/20; G06F 1/16

(52) U.S. Cl. 312/223.2; 361/679.6

(57) ABSTRACT

A covering for a computer case that combines elements of aesthetic and functional features. Attachment to the computer case optionally using magnets, clips and the like. Openings or openable doors to give access to functional buttons, ports and CD tray. Pockets to hold CD's and other like needs. Optional features could include a led lighting and vocal effects.

### FIELD OF THE INVENTION

This invention is in the field of computer case covers that have functional use in addition to aesthetic appearance.

### BACKGROUND OF THE INVENTION

Generally, computer cases are made of metal or plastic and cuboid in shape with plain functional features. Computer cases contain all the essential components of the personal computer, like for example, the mother board, hard discs, the processor and so on. These days most homes and almost every office contain at least one computer. They usually are placed close to the desk where a person sits to work or other uses of the computer like surfing the web or email communication.

The computer case often is placed on top of the desk or other visible place and is not a very aesthetic site.

Furthermore the fact the computer case is nearly always close by to the place a person works or spends significant amounts of time could be utilized more functionally than currently done.

This invention therefore reveals both aesthetic and functional uses of the computer case.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

The object of the invention is to have an aesthetic covering over the front panel of the computer case that has openable sections to reach functional buttons like the on/off button or access to CD trays or USB connectors and the like.

Another object of the invention is for there to be a convenient and practical method to attach the covering to and remove from the computer case. This could be by means of, for example, magnetic connection or straps of Velcro or simply fitted over the existing computer case.

Another object of the invention is for the said cover to have holes for ventilation opposite the holes for ventilation in the existing computer case and also to accommodate the electric wires and cables that connect to the computer.

Another object of the invention is for the said covering to contain various functionary jobs. For example, it could contain pockets on the part of the covering that is over the sides of the computer case. These pockets could be used to hold programs in the form of CD's or games or music and many times are damaged because they have no convenient place of storage. The pockets could also be used to hold a mobile phone or a small sized radio. Alternatively, a radio could be in-built in the covering.

Another object of the invention is to add elements of music and light to the case covering.

The covering could be just for the front cover of the computer or could also include the sides and back.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a drawing of a single panel for the front of a computer casing.

FIG. 2 is a drawing a facing for the front of a computer casing.

FIG. 3 is a drawing of a cover for a computer casing.

FIG. 4 is a drawing of a pocket holder that covers the top of a computer case.

FIG. 5 is a drawing of a cover for a computer casing with a disc rack.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

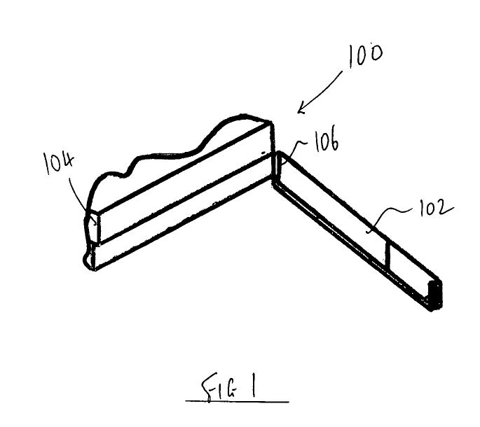

FIG. 1 shows a cover 100 for part of the front panel of a computer case. The part of the front panel being covered could be the CD tray or other part, which for aesthetic reasons or because of a functional need like for example keeping out dust, is beneficial to be covered. The cover 100 has a hinge 106 so that the front portion 102 can be opened and closed. The front facing 104 of the cover 100 could be decorative or contain decorative or other lighting.

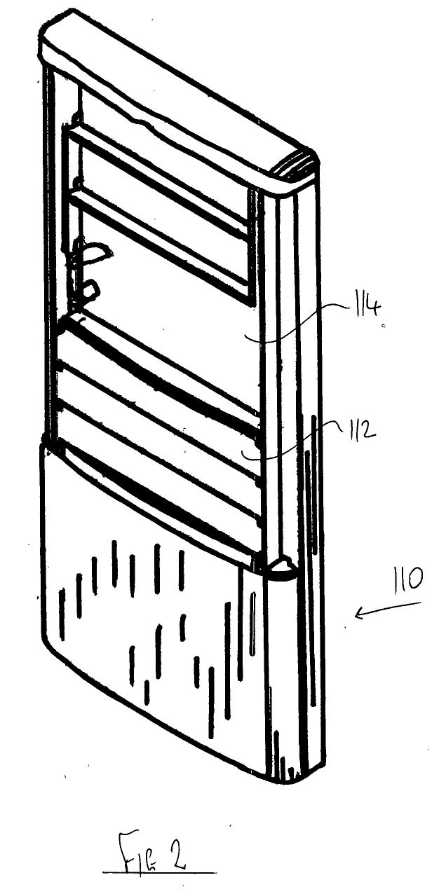

FIG. 2 shows a facing 110 for a computer case. The facing 110 has closed sections or slats 112 that are openable and portions 114 that are open, giving direct access to the computer front panel without opening a cover door. The facing 110 could attach to the computer front panel with magnets, Velcro, clips or by more permanent means.

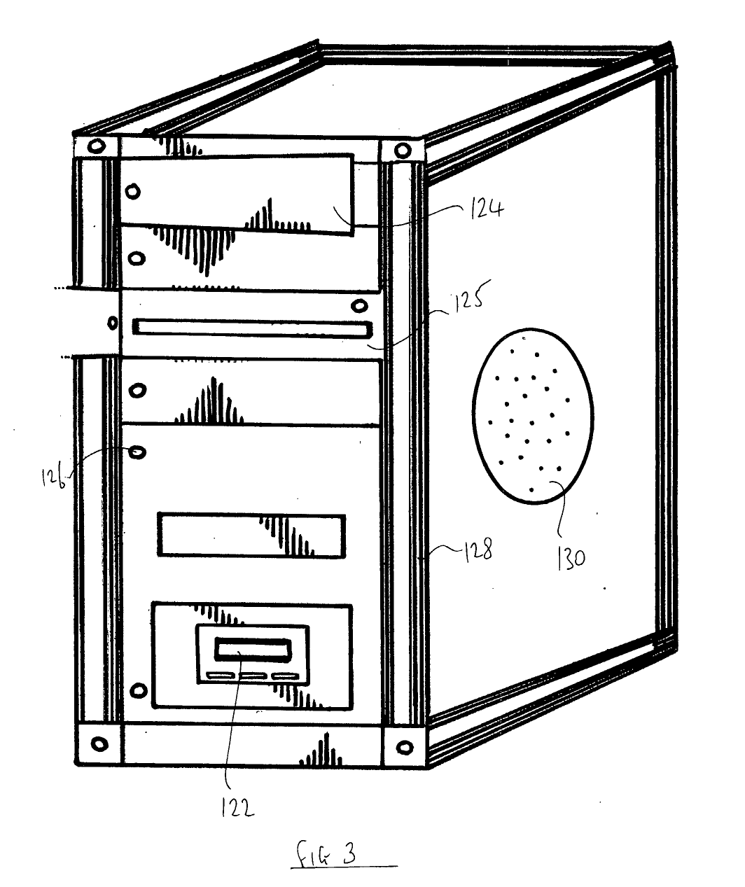

FIG. 3 shows a complete cover 120 for a computer case. The back of the cover could be partially open to accommodate the various connection cables that generally attach to the computer. The front portion of the cover could have openable sections 124. The door of section 125 is shown fully open revealing the CD tray. Access to regularly used connections like the UBS connection 122 could accessible without a cover door.

There could be lights 126 for decoration or vertical strip lighting 128. There could be perforations 130 at the sides to allow for ventilation.

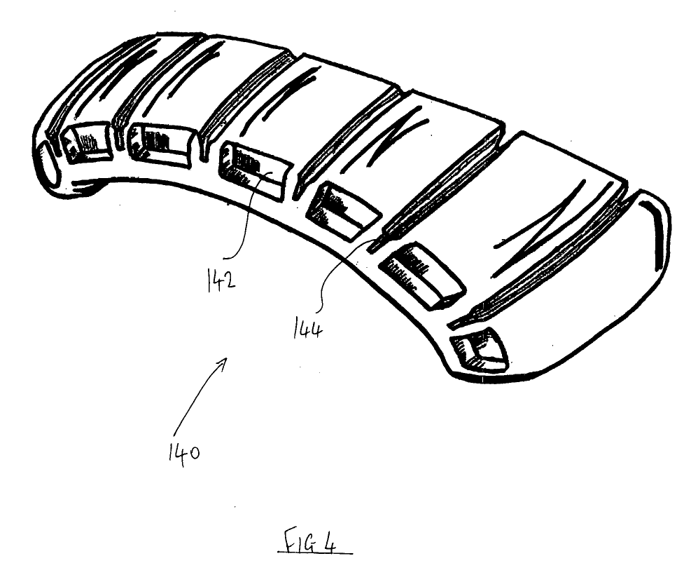

FIG. 4 shows a top cover 140 for a computer case. It could be held in place by fitting over the sides of the computer case or with an attaching device like for example, magnets or Velcro.

There could be pockets 142 for storage of items and slits 144 to accommodate CD or similar discs.

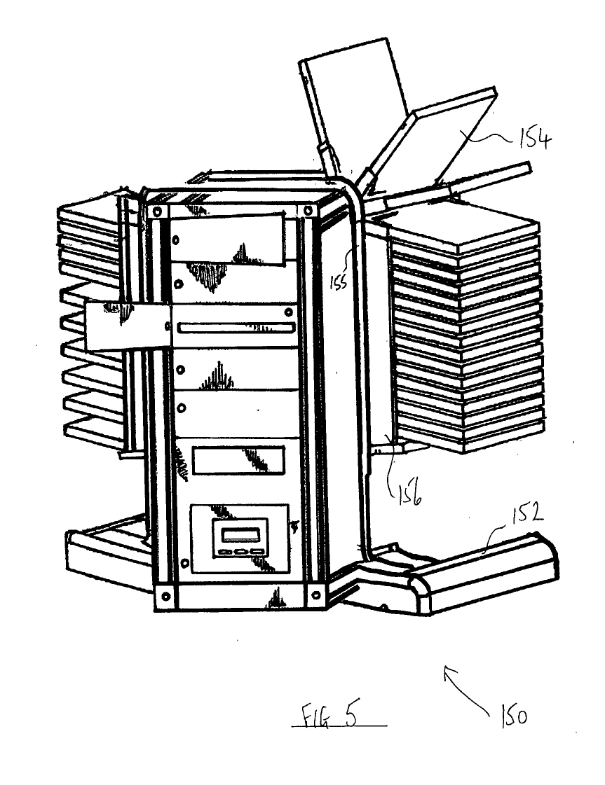

FIG. 5 shows a computer case cover 150 with the additional feature of a disc stand 152. There could be disc trays 154 that fit into and slide on the tubular frame 156 of the stand 152. Alternatively, the disc trays 154 could be attached to a rail 155 in such a way that the trays 154 move pivotally around the rail 155.

The disc stand 152 would enable search for and access to discs stored in the disc trays 154. The stand could be free standing being shaped around the computer case cover 150 or attached to the computer case cover 150 for greater stability.

What is claimed:

1. A device for a computer case cover comprising,
a. a panel attached to the computer case facing, covering at least a portion of the face of the computer case that contains the main control buttons,
b. openable and closeable parts in the said panel to gain access to the said buttons and connection sockets, like UBS,
c. spaces in the said panel to give uninhibited access to the said buttons and connection sockets,
d. at least one electrically powered light in the said computer case cover that is visible externally,
e. a means of attachment of the said panel to the said computer case by one or more of the following methods namely screws, clips, magnets, Velcro and close fitting to the said computer case, whereby computer cases are covered while keeping functional parts accessible.

2. A device for a computer case cover as claimed in claim 1 further comprising perforations in the said cover to allow access to air to and from the ventilated portions of the said computer.

3. A device for a computer case cover as claimed in claim 1 further comprising a cover for the top of the said computer case to assist the storage of discs and other items.

4. A device for a computer case cover as claimed in claim 1 further comprising a stand adjacent to at least one wall of the computer case where disc trays are attached to the said stand.

5. A device for a computer case cover as claimed in claim 4 wherein the said stand allows access to the said trays to insert and remove discs from the said trays.

6. A device for a computer case cover as claimed in claim 4 wherein the said disc trays are attached by two corners of the said trays being pivotally attached to the profile of the said stand.

7. A device for a computer case cover comprising,
a. a panel attached to the computer case facing, covering at least a portion of the face of the computer case that contains the main control buttons,
b. openable and closeable parts in the said panel to gain access to the said buttons and connection sockets, like UBS,
c. spaces in the said panel to give uninhibited access to the said buttons and connection sockets,
d. at least one electrically powered light in the said computer case cover that is visible externally,
e. a cover covering the remainder of the said computer case except leaving access for cables, connection sockets and ports,
f. perforated areas in the said cover to allow access to air, to and from the ventilated portions of the said computer,
g. a stand for holding at least one disc tray for holding discs of the kind useable in the said computer,
h. a radio receiver and loudspeaker,
i. a means of attachment of the said panel to the said computer case by one or more of the following methods namely screws, clips, magnets, Velcro and close fitting to the said computer case, whereby computer cases are covered while keeping functional parts accessible and offer convenient use of the surface area of the said computer case.

8. A device for covering the top portion of a computer case comprising pockets for storage and slits for housing discs used by the said computer, the said top cover being attached to the said computer case by one or more of the following methods namely screws, clips, magnets, Velcro and close fitting.
